(19) United States
(12) Patent Application Publication
(10) Pub. No.: US 2008/0068855 A1
(43) Pub. Date: Mar. 20, 2008

(54) Method for identifying critical circuits utilizing black light

(76) Inventors: Stuart Owen Goldman, Scottsdale, AZ (US); Richard E. Krock, Naperville, IL (US); Karl F. Rauscher, Emmaus, PA (US); Konrad Rauscher, Emmaus, PA (US); James Philip Runyon, Wheaton, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/512,681

(22) Filed: Aug. 30, 2006

(51) Int. Cl. F21V 29/00

(52) U.S. Cl. 362/544

(57) ABSTRACT

The present invention provides a communication facility that includes a plurality of communication circuits. At least one of the communication circuits is a critical communication circuit. The critical communication circuit includes a phosphor-enabled indication that becomes visible to the human eye when exposed to black light.

### FIELD OF THE INVENTION

The present invention relates generally to communication circuits in communications facilities, and more particularly to a method for identifying critical communications circuits in communications facilities.

### BACKGROUND OF THE INVENTION

Communications central offices and data centers may include hundreds of thousands of circuits. Some of these circuits are categorized as critical because they support “special” services. These services may include police and fire stations, emergency 911 call centers, hospitals, financial institutions and other stakeholders with special needs.

As shown in FIG. 1, current communications network operators use a process known as “red tagging” to mark such circuits. The U.S. Federal Communications Commission's Network Reliability and Interoperability Council's Best Practice guidance openly references this common practice in their public documents. FIG. 1 depicts a communication facility 100 including communication circuits 101-106 in accordance with the prior art. Communication circuits 101-106 provide communication for communication facility 100. Communication circuits 101, 102, and 104-106 are regular priority circuits, while circuit 103 is a critical circuit.

A circuit that is red-tagged has a red visual indicator 113 that can be readily seen by those in proximity to the equipment bays. Red-tagging may consist of an actual physical red tag, such as shown in FIG. 1, or the use of red plastic, where the regular circuits are white or some other color. Red tag 113 identifies marked circuit 103 as critical, and usually requires special procedures to be used when working on circuit 103.

Due to increased risks of terrorism or sabotage, the communications industry has been diligently reviewing its physical security and network security procedures. One challenge has been to effectively address the interests of identifying critical assets and simultaneously protecting them from malicious agents. On one hand, human procedural errors remain one of the major contributors to network outages, so marking critical circuits with red tags or the like offers considerable value. On the other hand, these critical sites are increasingly overseen with fewer and fewer personnel and co-location of many different operators in the same space is increasingly common.

Communications central offices and data centers are a rich target for terrorists or other malicious agents because they contain a highly dense concentration of critical assets. If an unauthorized person gained access to such a site, these critical circuits, such as circuit 103, can be an immediate attraction for damage. Since red-tagging is a well-know practice, even an unfamiliar person could readily identify that community's most critical circuits. Unlike the computer terminals that interface with the network elements, no passwords are required to see which circuits are critical. A community could experience an enormous negative impact in seconds by someone with bad intentions simply physically damaging, altering, or otherwise impairing these critical circuits. In addition, the malicious attack could be done clandestinely, so as to impede detection of the fault area along the circuit.

Therefore, a need exists for a method for identifying a critical circuit while making it difficult for the critical circuit to be sabotaged.

### BRIEF SUMMARY OF THE INVENTION

The present invention provides a communication facility that includes a phosphor-marked communication circuit. The phosphor-marked communication circuit is a critical circuit. A critical circuit is one that should be operational even in emergency circumstances, such as communication circuits relating to police, fire departments, emergency call centers, E911 call centers, hospitals, financial institutions, and other necessary communication links.

When exposed to visible light, no communication circuits indicate that they are critical. Under such lighting, there is no way to visibly detect that the communication circuit is a critical circuit.

When a technician desires to work on the communication facility, the technician illuminates the communication facility with a black light. When illuminated by a black light, the critical communication circuit displays an indication that shows that it is a critical circuit. The indication includes a phosphor that converts ultraviolet radiation into a specific color of visible light that looks brighter than a normal color. The indication can be added to the critical communication circuit using phosphorescent paint applied to the communication circuit, or via a sticker that includes a phosphorescent material. The indication is preferably applied such that it is unnoticeable in natural light and is only detectable when exposed to a black light.

When exposed to the light emanating from the black light, the critical communication circuit provides an indication that it is a critical circuit. This indication can be a particular color, can include text indicating that the circuit is a critical circuit, or can include a symbol or the like. In this manner, a service technician is alerted to the critical nature of the communication circuit prior to performing work on the communication facility, without displaying the critical nature of the communication circuit to those without a black light.

### BRIEF DESCRIPTION OF THE SEVERAL VIEWS OF THE DRAWINGS

FIG. 1 depicts a communication facility including communication circuits in accordance with the prior art.

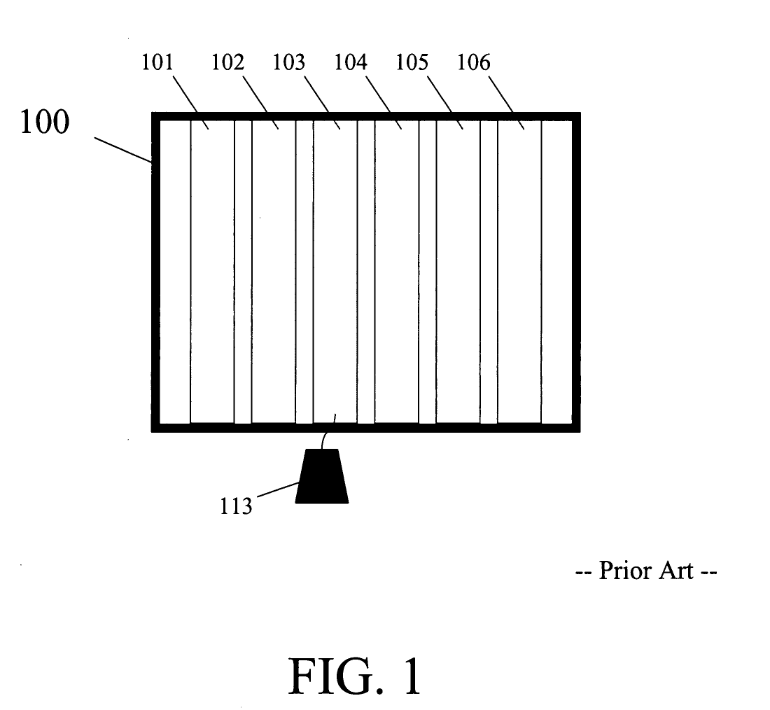

FIG. 2a depicts a communication facility including a phosphor-marked communication circuit while under natural light in accordance with an exemplary embodiment of the present invention.

FIG. 2b depicts a communication facility including phosphor-marked communication circuits while under black light in accordance with an exemplary embodiment of the present invention.

### DETAILED DESCRIPTION OF THE INVENTION

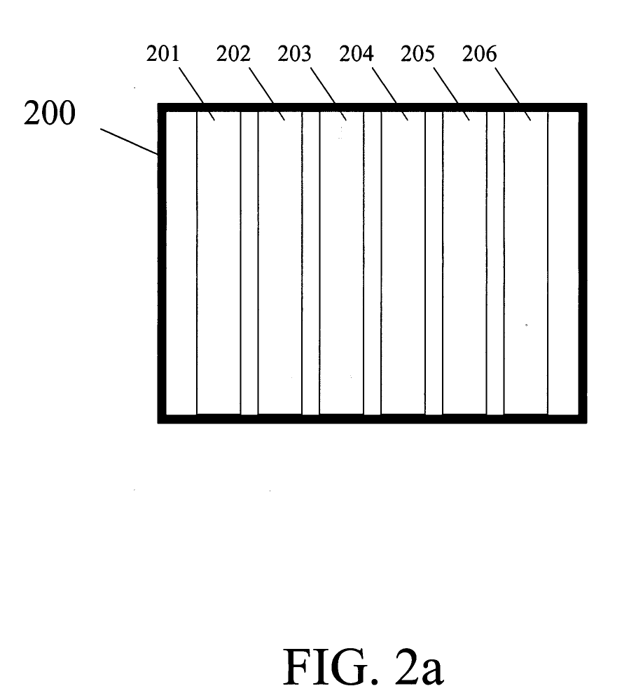

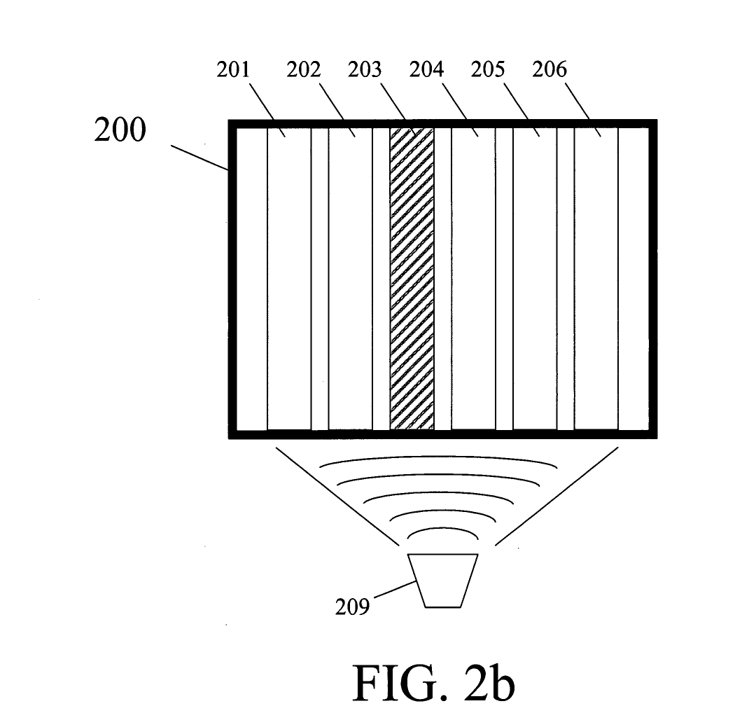

FIGS. 2a and 2b depict a communication facility 200 including a phosphor-marked communication circuit 203 in accordance with an exemplary embodiment of the present invention. FIG. 2a depicts communication facility 200 while illuminated by a visible light, while FIG. 2b depicts communication facility 200 while illuminated by a black light. As used herein, the term “black light” refers to light that is almost exclusively in the soft near ultraviolet range and includes very little visible light.

In the exemplary embodiment depicted in FIGS. 2a and 2b, communication facility 200 includes a plurality of communication circuits 201-206. Communication circuit 203 is a critical circuit. A critical circuit is one that should be operational even in emergency circumstances, such as communication circuits relating to police, fire departments, emergency call centers, E911 call centers, hospitals, financial institutions, and other necessary communication links.

As depicted in FIG. 2a, no communication circuits indicate that they are critical. FIG. 2a depicts communication facility 200 while under visible light as is common in communication centers. Such visible light is typically provided by ambinet sunlight or supplemental lighting, such as incandescent or fluorescent lighting. Under such lighting, there is no way to visibly detect that communication circuit 203 is a critical circuit.

Communication circuit 203 includes an indication that communication circuit 203 is a critical circuit. In an exemplary embodiment, the indication includes a phosphor that converts ultraviolet radiation into a specific color of visible light that looks brighter than a normal color. The indication can be added to communication circuit 203 using phosphorescent paint applied to communication circuit 203. Alternately, the indication can be a sticker that includes a phosphorescent material. The indication is preferably applied such that it is unnoticeable in natural light and is only detectable when exposed to a black light.

FIG. 2b depicts a communication facility 200 including a phosphor-marked communication circuit 203 while under black light in accordance with an exemplary embodiment of the present invention. In accordance with an exemplary embodiment, when work needs to be done on communication facility 200, the technician performing the work will use a black light 209 to illuminate communication facility 200, as depicted in FIG. 2b. Black light 209 is preferably a portable black light source, such as a flashlight or the like.

When exposed to the light emanating from black light 209, critical communication circuit 203 provides an indication that it is a critical circuit, as depicted in FIG. 2b. This indication can be a particular color, can include text indicating that the circuit is a critical circuit, or can include a symbol or the like. In this manner, a service technician is alerted to the critical nature of communication circuit 203 prior to performing work on communication facility 200. Yet the critical nature of communication circuit 203 is not visible to anyone without a black light, thereby enhancing the security communication facility 200, especially against sabotage, terrorism, or the like.

While this invention has been described in terms of certain examples thereof, it is not intended that it be limited to the above description, but rather only to the extent set forth in the claims that follow.

We claim:

1. A communication system comprising:
a communication facility including slots adapted for receiving a plurality of communication circuits; and
a communication circuit coupled to the communication facility, the communication circuit including a phosphor-enabled indication that becomes visible to the human eye when exposed to black light.

2. A communication system in accordance with claim 1, wherein the communication circuit includes a face plate, and wherein the phosphor-enabled indication is disposed on the face plate.

3. A communication system in accordance with claim 1, wherein the phosphor-enabled indication displays text when exposed to black light.

4. A communication system in accordance with claim 1, wherein the phosphor-enabled indication displays a symbol when exposed to black light.

5. A communication system in accordance with claim 1, wherein the phosphor-enabled indication displays a predetermined color when exposed to black light.

6. A method for identifying a critical communication circuit in a communication facility, the method comprising:
marking a critical communication circuit with an indication that is only visible when exposed to ultraviolet light; and
exposing the critical communication circuit to black light, wherein the black light causes the indication to become visible.

7. A method for identifying a critical communication circuit in accordance with claim 6, wherein the step of marking a critical communication circuit with an indication comprises marking a face plate of the communication circuit.

8. A method for identifying a critical communication circuit in accordance with claim 6, wherein the step of marking a critical communication circuit with an indication comprises marking the critical communication circuit with a phosphor-enabled indication.

9. A method for identifying a critical communication circuit in accordance with claim 8, wherein the phosphor-enabled indication is a phosphor-enabled paint.

10. A method for identifying a critical communication circuit in accordance with claim 8, wherein the phosphor-enabled indication is a phosphor-enabled marker.

11. A method for identifying a critical communication circuit in accordance with claim 6, wherein the step of marking a critical communication circuit with an indication comprises marking a critical communication circuit with an indication that displays text when exposed to black light.

12. A method for identifying a critical communication circuit in accordance with claim 6, wherein the step of marking a critical communication circuit with an indication comprises marking a critical communication circuit with an indication that displays a symbol when exposed to black light.

13. A method for identifying a critical communication circuit in accordance with claim 6, wherein the step of marking a critical communication circuit with an indication comprises marking a critical communication circuit with an indication that displays a predetermined color when exposed to black light.
